(19) United States
(12) Patent Application Publication
(10) Pub. No.: US 2007/0062639 A1
(43) Pub. Date: Mar. 22, 2007

(54) METHOD FOR MANUFACTURING A FLEXIBLE DISPLAY

(76) Inventors: Ku-Hsien Chang, Kaohsiung County (TW); Chi-Chang Liao, Tainan City (TW); Hsing-Lung Wang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,156

(22) Filed: Jan. 26, 2006

(30) Foreign Application Priority Data
Sep. 20, 2005 (TW) 94132412

(51) Int. Cl. B32B 7/14

(52) U.S. Cl. 156/291; 156/344

(57) ABSTRACT

The invention is directed to a method for supporting a flexible substrate. The method comprises steps of providing a supporting substrate and then forming an adhesive material layer on a surface of the supporting substrate, wherein the adhesive material layer is composed of a plurality of adhesive substances and the adhesive substances are located on the supporting substrate in a discrete arrangement. A flexible substrate is disposed on the supporting substrate, wherein the flexible substrate is attached onto the supporting substrate through the adhesive substances.

### CROSS-REFERENCE TO RELATED APPLICATION

This application claims the priority benefit of Taiwan application Serial no. 94132412, filed on Sep. 20, 2005. All disclosure of the Taiwan application is incorporated herein by reference.

### BACKGROUND OF THE INVENTION

1. Field of Invention

The present invention relates to a method for manufacturing an electronic device. More particularly, the present invention relates to a method for manufacturing a flexible display.

2. Description of Related Art

In the process for manufacturing a display, the current development trend is towards the use of the flexible substrate instead of the use of the glass substrate. In order to solve the problem due to the use of the flexible substrate in the manufacturing process, not only the manufacturing equipments need to be re-designed to be compatible with the flexible substrate but also the flexible substrate need to be supported by using the supporting substrate to be compatible with the well established manufacturing process. However, the result that the flexible substrate attaches onto the supporting substrate will affect the yield of the devices formed over the flexible substrates. The basic requirements for attaching the flexible substrate onto the supporting substrate comprise: (1) highly flatness; (2) no deformation of the supporting substrate is observed during the manufacturing process; (3) highly adhesion between the flexible substrate and the supporting substrate during the manufacturing process; (4) easy removal of the flexible substrate from the supporting substrate without damaging the devices formed on the flexible substrate; (5) excellent chemical-stability of the adhesive material between the flexible substrate and the supporting substrate under the manufacturing temperature and no residual adhesive on both substrates is observed after the flexible substrate is peeled from the supporting substrate; (6) re-cycling requirement of the supporting substrates to decrease the cost.

Currently, there are several methods for attaching the flexible substrate onto the supporting substrate. The flexible substrate can be attached onto the supporting substrate through an adhesive material entirely coating over the supporting substrate. The flexible substrate can be also attached onto the supporting substrate by using the vacuum attachment. Furthermore, the flexible substrate can be attached onto the supporting substrate by using a device to fix it. Among the aforementioned methods, entirely coating of the adhesive material over the supporting substrate needs large amount of adhesive material. Additionally, the thermal expansion coefficient of the adhesive material should be between those of the flexible and supporting substrates so that the stress resulted from the thermal expansion difference between two substrates under the thermal process can be diminished. Moreover, although entirely coating of the adhesive material over the supporting substrate can increase the adhesion between the flexible substrate and the supporting substrate, the de-bonding result cannot be well controlled by modifying the contact area between the flexible substrate and the supporting one while the flexible substrate is taken off from the supporting substrate. The only way to control the de-bonding result is to optimize the formula of the adhesive material. However, the cost of the research development is relatively high. Furthermore, the vacuum attachment is performed by using electrostatic chucking device under a vacuum environment. Nevertheless, the cost of the equipment used in the vacuum attachment is high and the air bubbles between the substrates are not easily removed under the vacuum environment. Furthermore, the displacement between the flexible and supporting substrates might easily occur. In addition, the de-bond of the flexible substrate performed by releasing the vacuum condition or using the assistant tools might result in apparent stress variation. Moreover, the lack of adhesive material between the flexible and supporting substrates might also cause the deformation of the supporting substrate without releasing the stress generated in the thermal process. Further, it is necessary to develop a new device for holding the supporting and the flexible substrates without adhesive and vacuum attachment so that the cost is high. Also, there are many limitations on using the carrier to carry the supporting substrate in the present equipments.

### SUMMARY OF THE INVENTION

Accordingly, at least one objective of the present invention is to provide a method for supporting a flexible substrate on a supporting substrate capable of preventing generation of bubbles in the adhesive material layer between the supporting and the flexible substrates.

At least another objective of the present invention is to provide a method for manufacturing a flexible display. By using the method of the present invention, after the devices are formed on the flexible substrate, the flexible substrate can be easily taken off from the supporting substrate without residual adhesive material on the flexible substrate.

To achieve these and other advantages and in accordance with the purpose of the invention, as embodied and broadly described herein, the invention provides a method for supporting a flexible substrate. The method comprises steps of providing a supporting substrate and then forming an adhesive material layer on a surface of the supporting substrate, wherein the adhesive material layer is composed of a plurality of adhesive substances and the adhesive substances are located on the supporting substrate in a discrete arrangement. A flexible substrate is disposed on the supporting substrate, wherein the flexible substrate is attached onto the supporting substrate through the adhesive substances.

In the preferred embodiment of the present invention, the adhesive substances are arranged discretely.

In the preferred embodiment of the present invention, the material for forming the supporting substrate is selected from a group consisting of plastic, glass or other refractory materials.

In the preferred embodiment of the present invention, the discrete arrangement is selected from a group consisting of a compact-and-complementary arrangement, an array arrangement and an irregular arrangement.

In the preferred embodiment of the present invention, the method for forming the adhesive material layer comprises step of performing a molding process, a printing process, embossing process or a photolithography process.

In the preferred embodiment of the present invention, the printing process is selected from a group consisting of a screen printing process, an inkjet printing process and a relief printing process.

In the preferred embodiment of the present invention, after the flexible substrate is attached onto the supporting substrate, it further comprises a step of performing a curing process to cure the adhesive material layer.

In the preferred embodiment of the present invention, the aforementioned curing process is selected from a group consisting of a thermal curing process, an ultraviolet curing process, electron-beam curing process and a laser curing process.

In the preferred embodiment of the present invention, the material of the adhesive material layer comprises the mixtures of glue and solid material.

In the preferred embodiment of the present invention, the aforementioned solid material used for controlling the thickness of adhesive substance is selected from a group consisting of fiber-or particle-type materials).

In the preferred embodiment of the present invention, the flexible substrate is used for manufacturing a flexible display device.

In the preferred embodiment of the present invention, the flexible substrate is a plastic substrate or a metal foil substrate.

The present invention also provides a method for manufacturing a flexible display. The method comprises steps of providing a supporting substrate and then forming a plurality of adhesive substances on the surface of the supporting substrate, wherein the adhesive substances are located on the supporting substrate in a discrete arrangement. A flexible substrate is disposed on the supporting substrate, wherein the flexible substrate is attached to the supporting substrate with the adhesive substances. A series of display manufacturing processes is further carried out to form a plurality of display devices on the flexible substrate. The flexible substrate is taken off from the supporting substrate.

In the preferred embodiment of the present invention, the adhesive substances are arranged discretely.

In the preferred embodiment of the present invention, the materials of the supporting substrates are selected from a group consisting of plastic, glass or other refractory materials.

In the preferred embodiment of the present invention, the discrete arrangement is selected from a group consisting of a compact-and-complementary arrangement, an array arrangement and an irregular arrangement.

In the preferred embodiment of the present invention, the method for forming the adhesive substances comprises step of performing a molding process, a printing process, embossing process or a photolithography process.

In the preferred embodiment of the present invention, the material of the adhesive substances comprises the mixtures of glue and solid material.

In the preferred embodiment of the present invention, the aforementioned solid material is used for controlling the thickness of adhesive substance, and selected from a group consisting of fiber-or particle-type materials.

In the preferred embodiment of the present invention, the method for separating the flexible substrate from the supporting substrate is selected from a group consisting of a heating process, a cooling process, an irradiation process and a soaking process performed with a stripper solution.

In the present invention, since the plurality of adhesive substances between the supporting substrate and the flexible substrate is located in a discrete arrangement, the adhesive substances not only provide a better adhesive effect, but also are easier removal of flexible substrate from the supporting one. Therefore, the problem that the adhesive material, which is entirely coating over the supporting substrate, remains on the flexible substrate can be overcome. The design of the discrete arrangement provides channels for the air bubbles generated in the adhesive material to escape and prevents the permeation of solutions during the wet processes.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1B are cross-sectional views illustrating a method for supporting a flexible substrate according to a preferred embodiment of the invention.

FIGS. 2A through 2E are schemas showing various arrangements of the adhesive substances according to one preferred embodiment of the invention.

FIG. 3 is a flow chart illustrating a method for manufacturing a flexible display according to another preferred embodiment of the present invention.

### DESCRIPTION OF THE PREFERRED EMBODIMENTS

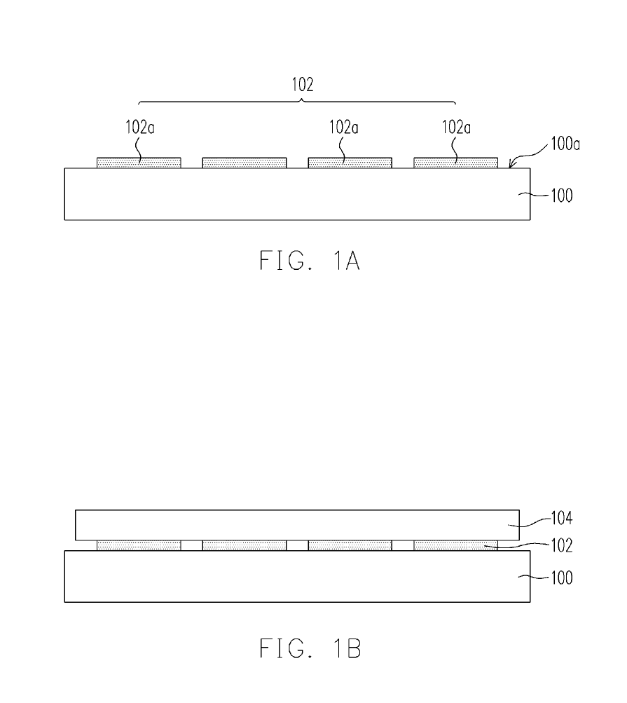

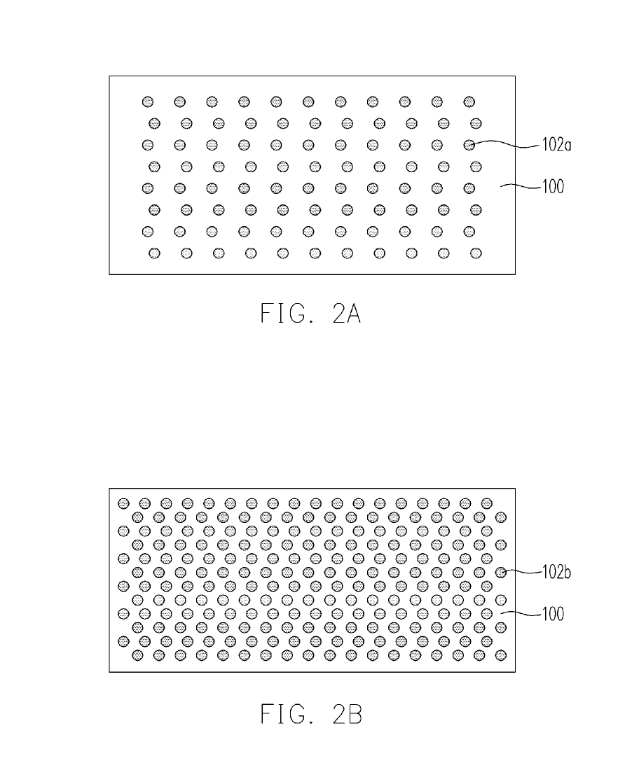

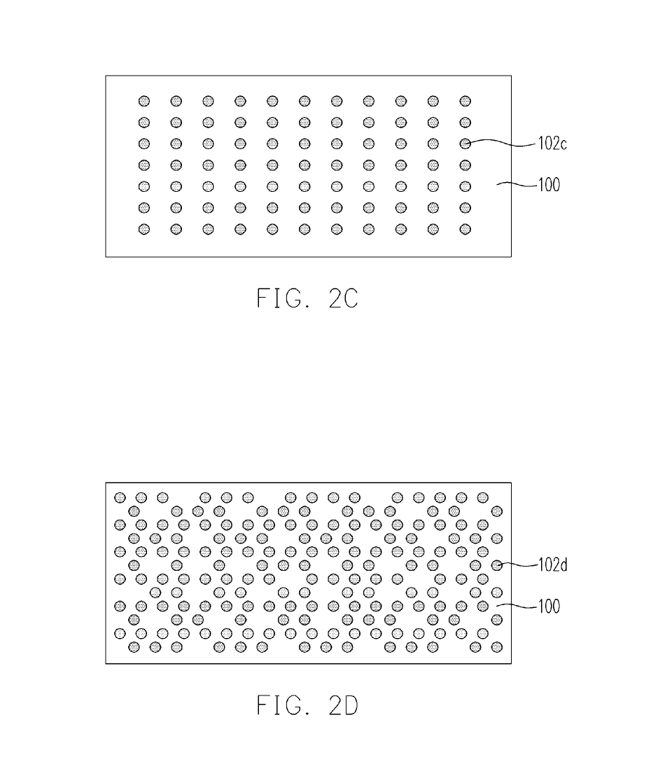

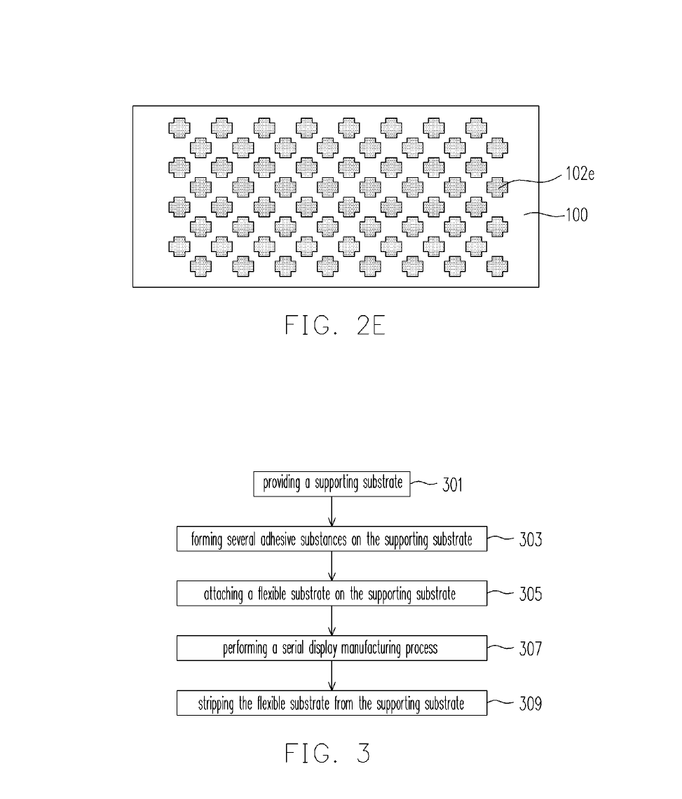

FIGS. 1A through 1B are cross-sectional views illustrating a method for supporting a flexible substrate according to a preferred embodiment of the invention. As shown in FIG. 1A, a supporting substrate 100 is provided. The supporting substrate 100 is disposed on a carrier (not shown) and the material of the supporting substrate 100 includes, for example but not limited to, refractory material. Preferably, the material of the supporting substrate 100 is plastic or glass. Thereafter, an adhesive material layer 102 is formed on a surface of the supporting substrate 100. The adhesive material layer 102 is composed of several adhesive substances 102a. The adhesive substances 102a are located on the supporting substrate 100 in a discrete arrangement. FIGS. 2A through 2E are schemas showing various arrangements of the adhesive substances according to one preferred embodiment of the invention. As shown in FIGS. 2A, 2B, 2C, 2D and 2E, the aforementioned discrete arrangement can be, for example, a compact-complementary arrangement (as shown in FIGS. 2A, 2B and 2E), an array arrangement (as shown in FIG. 2C) or an irregular discrete arrangement (as shown in FIG. 2D). Moreover, as shown in FIGS. 2A and 2B, by changing the distributed density of the adhesive substances 102a, the adhesion between the flexible substrate and the supporting substrate can be well adjusted (the distributed density of the adhesive substances in FIG. 2A is smaller than that in FIG. 2B). In the present invention, the shape of each adhesive substance is not limited to the shape shown in this embodiment. The shape of each adhesive substance and the arrangement of the adhesive substances should comply with the concept that the adhesive substances are located on the supporting substrate in a discrete arrangement.

The method for forming the adhesive material layer 102 can be, for example but not limited to, a molding process, a printing process, embossing process or a photolithography process. The molding process comprises steps of forming an adhesive layer all over the supporting substrate and then impressing the patterns of the adhesive substance onto the adhesive layer with the use of a female mold. The female mold is removed and the patterned adhesive material layer composed of several adhesive substances is formed on the supporting substrate. Furthermore, the embossing process comprises steps of dipping a male mold having the patterns of the adhesive substances with an adhesive material and then impressing the male mold onto the supporting substrate. The male mold is removed to form a patterned adhesive material layer on the supporting substrate.

The printing process can be, for example but not limited to, a screen printing process, an inkjet printing process or a relief printing process to print the adhesive material onto the supporting substrate to form a patterned adhesive material layer composed of several adhesive substances. The material of the adhesive material layer can be, for example but not limited to, a mixture comprising glue and solid material. The solid material can provide a uniform thickness of the adhesive material layer and further provide a relatively firm supporting structure for later disposed flexible substrate over the supporting substrate. The hard material can be, for example but not limited to, fiber- or particle-type materials.

Since the adhesive substances 102a are arranged discretely, the problem that the air bubbles in the adhesive material layer, which is entirely covering the supporting substrate, are not easily expelled can be solved. Furthermore, the adhesive substances 102a are arranged discretely so that, after the devices formed over the flexible substrate over the supporting substrate, it's possible for the flexible substrate to be easily peeled from the supporting substrate without having the adhesive material remaining on the flexible substrate.

As shown in FIG. 1B, a flexible substrate 104 is disposed over the supporting substrate 100 and the flexible substrate 104 is attached to the supporting substrate 100 through the adhesive substances 102a. The flexible substrate 104 can be, for example but not limited to, a plastic substrate or a metal foil substrate. Then, a curing process is performed to cure the adhesive material layer 102 after the flexible substrate 104 is attached to the supporting substrate 100. The curing process can be, for example but not limited to, a thermal curing process, an ultraviolet curing process, electron-beam curing process or a laser curing process. Additionally, when the material of the adhesive material layer 102 is a pressure sensitive material, a pressure can be applied on the flexible substrate 104 to fix the flexible substrate 104 over the supporting substrate 100 after the curing process is performed.

FIG. 3 is a flow chart illustrating a method for manufacturing a flexible display according to another preferred embodiment of the present invention. The method for supporting the flexible substrate can be applied to the process for manufacturing a flexible display to support the flexible substrate. As shown in FIG. 3, in the step 301, a supporting substrate (the supporting substrate 100 shown in FIG. 1A) is provided. In the step 303, several adhesive substances (the adhesive substances 102a shown in FIG. 1A) are formed on a surface of the supporting substrate. In the step 305, a flexible substrate used for forming display devices thereon is attached on the supporting substrate through the adhesive substances (as shown in FIG. 1B in the previous embodiment). Thereafter, in the step 307, a series of display manufacturing processes is performed to form several display devices over the flexible substrate. The display device can be, for example but not limited to, thin film transistor, liquid crystal device or light emitting diode (LED). Then, the flexible substrate is taken off from the supporting substrate. The method for separating the flexible substrate from the supporting substrate can be a heating process, a cooling process, an irradiation process or a soaking process performed with a stripper solution to decompose the adhesive substances in order to remove the adhesion between the flexible substrate and the supporting substrate. Further, the stripper solution can be, for example but not limited to, an acid solution, a basic solution or an organic solution.

In the present invention, since the adhesive material layer is composed of several adhesive substances are located between the supporting substrate and the flexible substrate in a discrete arrangement, the problem that the air bubbles in the adhesive material layer, which is entirely covering the supporting substrate, are not easily expelled can be solved. Furthermore, due to discrete arrangement of the adhesive substances 102a, the flexible substrate can be easily peeled from the supporting substrate without remaining the adhesive material on the flexible substrate after the devices formed over the flexible substrate over the supporting substrate. Additionally, the distributive density, patterns and thickness of the adhesive substances can be adjusted to control the adhesion between the supporting substrate and the flexible substrate. Therefore, the cost can be reduced.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for supporting a flexible substrate, comprising:
providing a supporting substrate;
forming an adhesive material layer on a surface of the supporting substrate, wherein the adhesive material layer is composed of a plurality of adhesive substances and the adhesive substances are located on the supporting substrate in a discrete arrangement; and
disposing a flexible substrate on the supporting substrate, wherein the flexible substrate is attached onto the supporting substrate through the adhesive substances.

2. The method of claim 1, wherein the adhesive substances are arranged discretely.

3. The method of claim 1, wherein the material for forming the supporting substrate is selected from a group consisting of plastic, glass or other refractory materials.

4. The method of claim 1, wherein the discrete arrangement is selected from a group consisting of a compact-and-complementary arrangement, an array arrangement and an irregular arrangement.

5. The method of claim 1, wherein the method for forming the adhesive material layer is selected from a group consisting of a molding process, a printing process, embossing process and a photolithography process.

6. The method of claim 5, wherein the printing process is selected from a group consisting of an screen printing process, a inkjet printing process and a relief printing process.

7. The method of claim 1, after the flexible substrate is attached onto the supporting substrate, further comprising a step of performing a curing process to cure the adhesive material layer.

8. The method of claim 7, wherein the curing process is selected from a group consisting of a thermal curing process, an ultraviolet curing process, electron-beam curing process and a laser curing process.

9. The method of claim 1, wherein the material of the adhesive material layer includes a mixture of glue and solid material.

10. The method of claim 9, wherein the solid material is selected from a group consisting of fiber-or particle-type materials.

11. The method of claim 1, wherein the flexible substrate is used for manufacturing a flexible display device.

12. The method of claim 1, wherein the flexible substrate is a plastic substrate or a metal foil substrate.

13. A method for manufacturing a flexible display, comprising:
providing a supporting substrate;
forming a plurality of adhesive substances on a surface of the supporting substrate, wherein the adhesive substances are located on the supporting substrate in a discrete arrangement;
disposing a flexible substrate on the supporting substrate, wherein the flexible substrate is attached to the supporting substrate through the adhesive substances;
performing a series of display manufacturing processes to form a plurality of display devices on the flexible substrate; and
separating the flexible substrate from the supporting substrate.

14. The method of claim 13, wherein the adhesive substances are arranged discretely.

15. The method of claim 13, wherein the material of the supporting substrate is selected from a group consisting of plastic, glass or other refractory materials.

16. The method of claim 13, the discrete arrangement is selected from a group consisting of a compact-and-complementary arrangement, an array arrangement and an irregular arrangement.

17. The method of claim 13, wherein the method for forming the adhesive substances is selected from a group consisting of a molding process, a printing process, embossing process and a photolithography process.

18. The method of claim 13, wherein the material of the adhesive substances includes a mixture of glue and solid material.

19. The method of claim 18, wherein the solid material is selected from a group consisting of fiber-or particle-type materials.

20. The method of claim 13, wherein the method for separating the flexible substrate from the supporting substrate is selected from a group consisting of a heating process, a cooling process, an irradiation process and a soaking process performed with a stripper solution.
